(19) United States
(12) Patent Application Publication
(10) Pub. No.: US 2007/0284881 A1
(43) Pub. Date: Dec. 13, 2007

(54) Energy generation device adaptable to a means of rotation

(76) Inventors: Brian McLaughlin, Hermosa Beach, CA (US); Jennifer Berger, Lima, OH (US)

Correspondence Address: Brian James McLaughlin, Jennifer Berger, 1211 Lakewood Ave, Lima, OH, 45805, US

(21) Appl. No.: 11/807,432

(22) Filed: May 29, 2007

Related U.S. Application Data
(60) Provisional application No. 60/809,858, filed on Jun. 1, 2006.

(51) Int. Cl. H02K 7/18; F03G 7/08; F02B 63/04

(52) U.S. Cl. 290/1 R

(57) ABSTRACT

This invention is an energy generating device adaptable to a “means of rotation” which captures human energy by converting it to usable energy. This process occurs through the conversion of energy from the body to a “means of rotation” to an alternator to a battery. Then, the battery's output energy, which is in the form of direct current (DC), may be sent either to a DC appliance or through an inverter that transforms it into alternating current (AC), which is used by most modern electronics and appliances. This invention overcomes five key elements: an alternator's “turn on speed” (minimum revolutions per minute required for the alternator to begin producing its specified output voltage), torsion force required by the alternator at the “turn on speed”, coefficient of friction required, tension requirements and specific voltage regulation/generation. Energy measuring device(s) may be associated with the energy generating device to measure the voltage output and the amperage output. Input device(s) may be associated with the energy measuring device and the energy generating device to associate the revolutions per minute (RPM) with the predicted output of the alternator, showing the user the performance curve of RPM versus the power being generated.

### BACKGROUND OF THE INVENTION

The present invention creates clean energy through the utilization of kinetic energy generated by the user, through a means of rotation, which is then converted, using an alternator and the rubber drive shaft, into potential energy that can be stored in a common 12 Volt battery.

The use of a bicycle or means of rotation to generate energy is, to some degree, known and documented. However, these current and prior designs are not compatible with a more powerful energy generating device, a single-wire alternator, and do not take into account the necessary design specifications to capture this energy being generated. For example, this invention overcomes the five key elements of an alternator's “turn on speed” (minimum revolutions per minute required for the alternator to begin producing power at its specified output voltage), torsion force required by the alternator at its “turn on speed”, coefficient of friction required, tension requirements and specific voltage regulation/generation.

Therefore, there is a need for a design that overcomes the limitations inherent in current and prior designs.

“Means of rotation” and alternators are well known for their respective functions. More specifically, alternators are common charging and energy producing devices coupled with belts and chains, and “means of rotation” are commonly used for transportation. However, unique to this design, there is engineering to account for the alternator's “turn on speed” (average alternator “turn on speed” 1000 RPM), torsion force at “turn on speed” (up to 9 hp), high tension applied, increased level of coefficient of friction (using a solid rubber drive shaft in place of the alternator's pulley) and specific voltage regulation (internally regulated alternators output to a steady charging range between 12-14 Volts). These five key elements, never before designed for a single-wire alternator, allow for this unique form of an energy generating device.

An additional problem in the current and prior designs is that the design specifications are chosen for a generator and do not account for the design modifications necessary to operate with an alternator. This is especially important because a form of an energy generating device is in existence where a generator, together with a bicycle, is used to create energy. But that device is different from the principles of using a common single-wire alternator and a unique rubber drive shaft (with sufficient coefficient of fiction and tension to overcome the torsion at the alternator “turn on speed”) to reach the goal of humans creating clean energy.

The key difference between an alternator and a generator is what spins and what is fixed. On a generator, windings of wire (the armature) spin inside a fixed magnetic field. On an alternator, a magnetic field is spun inside of windings of wire, called a stator, to generate the electricity. This allows the wires to be directly and easily connected to their outputs without the need for sliding contacts to carry the relatively high output current. The magnetic field is still generated via electro magnets mounted on a rotor, and the relatively small field current that powers them is supplied to the rotor by two small brushes that each ride on separate and continuous slip rings. These smooth slip rings (unlike the comparatively rough contacts on a commutator in a generator), combined with the fact that the relatively heavy windings are fixed instead of rotating, allow the alternator to be spun at much higher speeds. The alternator's smooth slip rings are especially important because they prove that prior design specifications never actually designed for an alternator. Using a generator, the prior designs call for adding mass to smooth the process of rotating a crank. Clearly this mass is not part of the design with an alternator as the energy source.

This unique invention, utilizing an alternator, may be spun fast enough to reach its turn on RPMs to produce higher levels of watts for user needs than with a similar sized generator. Alternators have been created to be more efficient and achieve constant states of high wattage output, which is why they are taking the place of generators in most instances.

The difference between an average alternator and a single-wire alternator is that the single-wire alternator must, by definition, regulate its output voltage. The designer of the regulator has to allow for some defined amount of voltage drop through the wiring to keep the battery at the desired 13.8-14 volts. If the resistance in the alternator circuit is higher than what was anticipated, then the battery will be undercharged. Likewise, if the resistance is lower than what was anticipated, then the battery may be overcharged. The single-wire alternator simplifies the design such that it eliminates the need for external voltage regulation between the alternator and the power storage device.

Accordingly, there exists today a need for the present invention which helps ameliorate the prior art limitations and adequately designs for a more powerful energy source, the alternator, while overcoming the five key design elements mentioned above.

### SUMMARY OF THE INVENTION

In an embodiment, the present invention provides clean energy produced by the user, utilizing a “means of rotation” mounted to a single-wire alternator and associated conductors and power storage elements.

This system is designed specifically for an alternator (which has smoother and higher power output than a generator) and tailored in such a way as to enable the successful conversion of the user's kinetic energy via the “means of rotation” to stored energy. The captured human energy is safely transferred and stored in a common DC battery. From here, the energy is sent to either a DC appliance or an inverter, which transforms the energy from DC to AC so that it can be used to power common AC electronics and appliances. The invention enables common single-wire alternators to be used effectively and efficiently to produce clean energy.

The transfer of energy from the user to the “means of rotation” to the alternator's rubber drive shaft is enabled by the mount of the alternator to the “means of rotation,” through which sufficient stability and tension are applied. The rubber drive shaft is needed to provide a sufficient level of friction between the “means of rotation” and the alternator's shaft. This energy is safely transferred through wires connecting the battery and alternator, but their interconnection is a common safety connector which ensures that the user only connects the correct corresponding positive and negative terminals when necessary. A performance curve may be extracted, indicating the product of volts and amperage together graphed against the user's RPMs. This shows the user the power “wattage” output versus the number of revolutions per minute. The amount of possible energy that can be produced by the energy generation device is sufficiently high, and can power numerous appliances either real-time or at a later time since it can be stored in a common DC battery or other safe power storage devices.

The safety housing for the battery allows it to be safely stored, significantly lowering the potential of shocking the user. The optional wheels on the battery's safety housing allow the battery/power storage unit to be portable and easily moved to different areas with minimal effort.

The results and impacts of the use of this energy generation device are measurable and will aid in the revitalization of the ozone and environment through the creation and use of clean energy.

### BRIEF DESCRIPTION OF THE DRAWINGS AND PICTURES

FIG. 1 is a side view in perspective of a means of rotation attached to an energy generation device.

FIG. 2 is a rear view in perspective of a single-wire alternator and its associated attachments to a means of rotation.

FIG. 3 is a rear view in perspective of a single-wire alternator and stand without a means of rotation.

FIG. 4 is a side view in perspective of the alternator and stand partially shown in FIG. 1.

FIG. 5 is a side view in perspective of the alternator and the rubber drive shaft partially shown in FIG. 1.

### DESCRIPTION OF THE PREFERRED EMBODIMENT

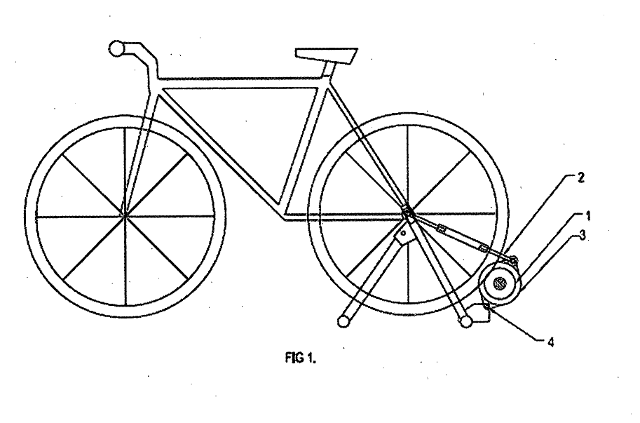

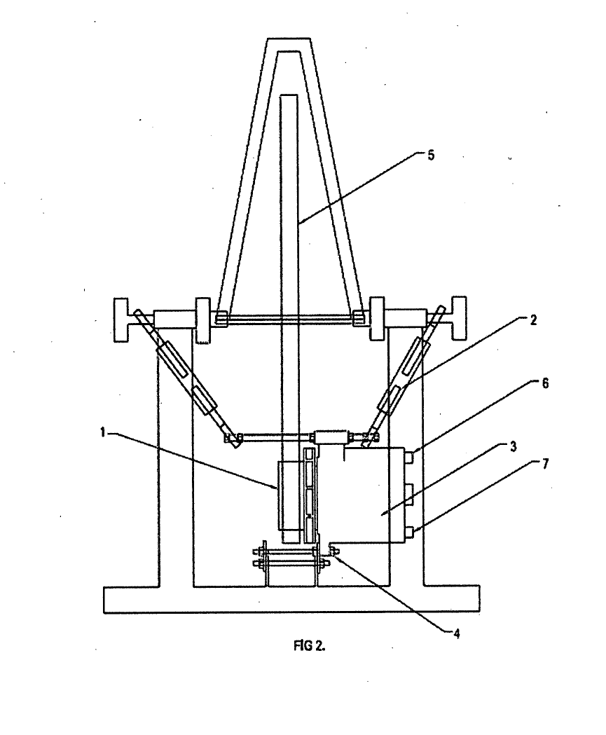

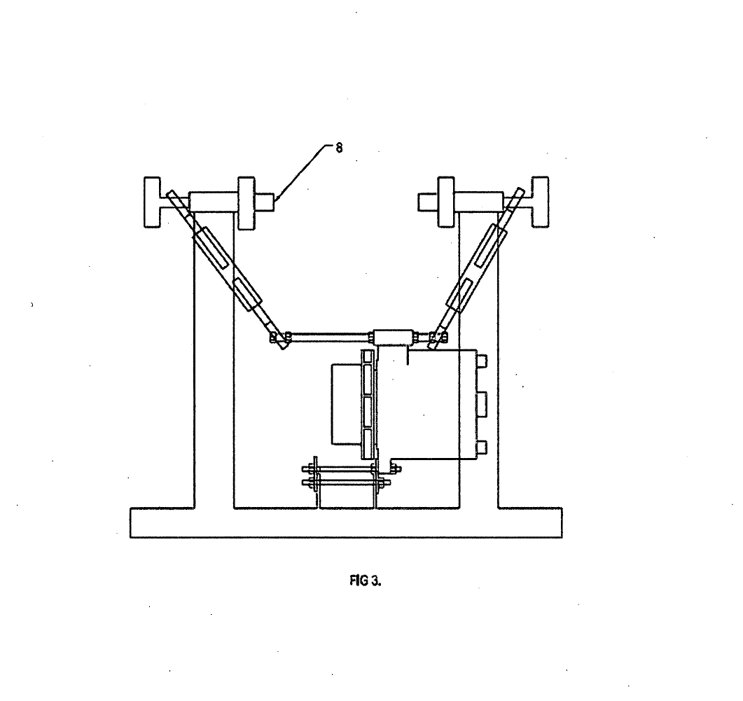

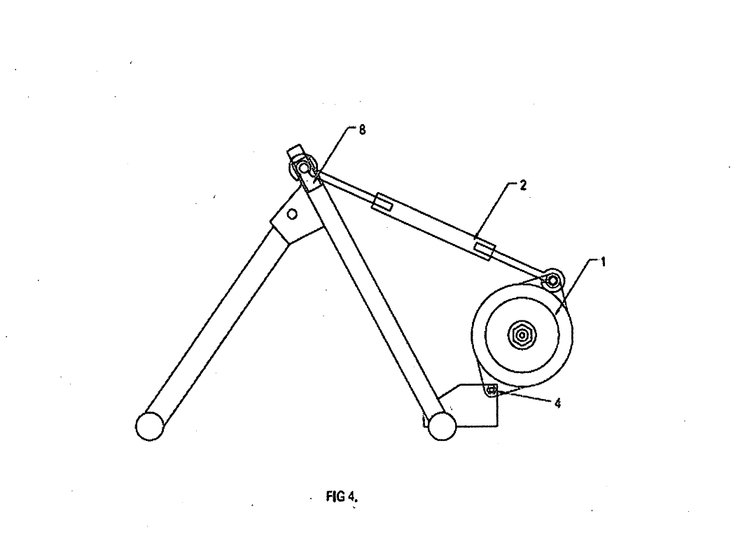

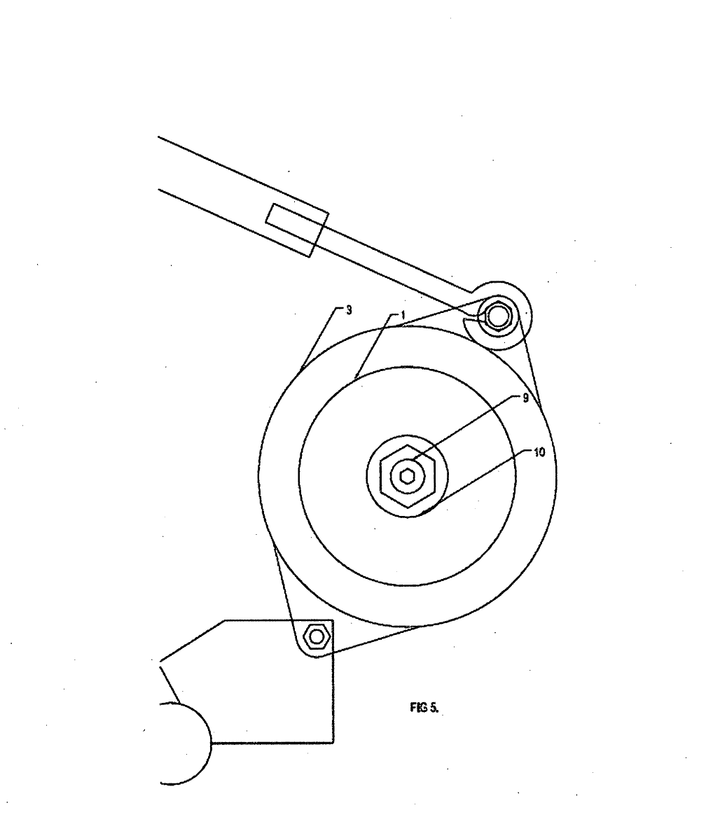

As displayed in the drawings, FIG. 1 through FIG. 5, a new alternative energy generation device embodying the necessary attributes to overcome the principles of coefficient of friction, tension forces, specific voltage regulation, alternator turn on speed and alternator torque will be further described below.

As illustrated in FIG. 1, the energy generating device utilizes a common single-wire alternator 3 aligned with a means of rotation 5. The alignment is such that the means of rotation directly contacts and forces the spinning of the alternator's solid rubber drive shaft. The spinning of the alternator shaft must be consistent with the “right hand rule” to allow the flow of electrons from only two output connections 6 and 7 to a battery (alternator voltage regulation is accomplished internally).

A single-wire alternator 3 is mounted to a frame 8 by using the alternator's preexisting mounts, common nuts and bolts, and without modifying the alternator's mounts. This description covers the lower mounting 4 of the single-wire alternator to the frame, whereby the mount allows the single-wire alternator one degree of freedom (forward and back swivel based on a pivot point). The upper mount utilizes a bolt consistent with a common alternator, associated nuts, and at a minimum two adjustable tension rods 2. These design specifications make the device adaptable to any means of rotation, whereby sufficient tension may be applied from the rubber drive shaft to that means of rotation.

A rubber drive shaft 1 is milled out in two places. First, the rubber drive shaft is completely hollowed out to fit the alternator's preexisting metal drive shaft 9. Then, the rubber drive shaft is milled out 10 to allow for a bolt (which is common to most alternator shafts/pulleys) to be wrenched down in the center of the rubber drive shaft, securing it to the alternator shaft. The thickness and diameter of the rubber drive shaft allow for sufficient contact with the means of rotation, such that a necessary level of coefficient of friction is reach while allowing the means of rotation the ability to achieve a high enough rotational speed to surpass the alternator's turn on speed.

It is to be understood that with respect to the description above, the dimensional relationships for the subsystems and parts of the invention, to include variations in size, form, fit, function and operation, are deemed obvious to one skilled in the art, and all equivalent relationships to those described above and illustrated in the drawings are intended to be encompassed by the present invention.

While this invention has been described in conjunction with the specific embodiments outlined above, it is evident that many alternatives, modifications and variations will be apparent to those skilled in the art. Accordingly, the embodiments of the invention as set forth above are intended to be illustrative, not limiting. Various changes may be made without departing from the spirit and scope of the invention.

We claim:

1. An energy generating device adaptable to a “means of rotation” utilizing a single-wire alternator mounted with sufficient tension, directly contacting the “means of rotation” with a sufficient coefficient of friction factor to capture the kinetic energy generated by the user to overcome the torsion force applied by the alternator once it reaches it's “turn on speed,” hence producing power at its specified and internally regulated output voltage.

2. An energy generating device according to claim 1, where the alternator mount provides flexibility and universal adaptability enabling the pulley to be directly touching the “means of rotation,” providing sufficient tension, hence enabling more friction and necessary surface area to overcome the turn on resistance provided by the alternator at the “turn on speed.”

3. An energy generating device according to claim 1, where an alternator's pulley adaptation provides the necessary coefficient of friction, using a solid rubber drive shaft, to surpass the torsion force of the alternator as the RPMs reach the “turn on speed” (set specific for each alternator). The alternator's rubber drive shaft has the specifications such that the pulley ratio of the diameter of the “means of rotation” to the alternator's pulley adaptation diameter is such that it is sufficient to reach the “turn on speed” of an alternator while maintaining the necessary coefficient of friction to overcome the torsion force.
